(19) United States
(12) Patent Application Publication
(10) Pub. No.: US 2005/0285445 A1
(43) Pub. Date: Dec. 29, 2005

(54) Battery management system

(75) Inventors: William J. Wruck, Whitefish Bay, WI (US); Majid Taghikhani, Franklin, WI (US); Steven J. Wood, Shorewood, WI (US); Wen-Hong Kao, Brown Deer, WI (US); Ronald C. Miles, Milwaukee, WI (US); Edward N. Mrotek, Grafton, WI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 11/165,621

(22) Filed: Jun. 22, 2005

Related U.S. Application Data
(63) Continuation of application No. PCT/US04/01187, filed on Jan. 6, 2004.
(60) Provisional application No. 60/438,119, filed on Jan. 6, 2003.
(60) Provisional application No. 60/438,136, filed on Jan. 6, 2003.
(60) Provisional application No. 60/438,143, filed on Jan. 6, 2003.
(60) Provisional application No. 60/438,137, filed on Jan. 6, 2003.
(60) Provisional application No. 60/438,120, filed on Jan. 6, 2003.
(60) Provisional application No. 60/438,138, filed on Jan. 6, 2003.

(51) Int. Cl. B60L 1/00

(52) U.S. Cl. 307/10.1; 307/12

(57) ABSTRACT

A method and system for managing a battery system for a vehicle utilizes a hierarchy to disconnect electrical loads from the battery system. One embodiment of the method includes receiving an input signal representative of a condition of one of the components of one of the systems provided in a vehicle. The method also includes comparing the input signal with at least one parameter to determine whether the condition indicates that at least one of the plurality of electrical loads should be disconnected from the battery. The method also includes disconnecting at least one of the plurality of electrical loads from the at least one battery according to a predetermined hierarchy if the input signal when compared to the parameter indicates that at least one of the plurality of electrical loads should be disconnected from the at least one battery.

### CROSS-REFERENCE TO RELATED PATENT APPLICATIONS

This application is a continuation of International Application No. PCT/US2004/001187 titled “Battery Management System” filed on Jan. 6, 2004, which claims the benefit of U.S. Provisional Patent Application No. 60/438,143, filed Jan. 6, 2003; U.S. Provisional Patent Application No. 60/438,136, filed Jan. 6, 2003; U.S. Provisional Patent Application No. 60/438,120, filed Jan. 6, 2003; U.S. Provisional Patent Application No. 60/438,137, filed Jan. 6, 2003; U.S. Provisional Patent Application No. 60/438,138, filed Jan. 6, 2003; and U.S. Provisional Patent Application No. 60/438,119, filed Jan. 6, 2003.

The disclosures of the following applications are incorporated herein in their entirety: International Application No. PCT/US2004/001187, filed Jan. 6, 2004; U.S. Provisional Patent Application No. 60/438,143, filed Jan. 6, 2003; U.S. Provisional Patent Application No. 60/438,136, filed Jan. 6, 2003; U.S. Provisional Patent Application No. 60/438,120, filed Jan. 6, 2003; U.S. Provisional Patent Application No. 60/438,137, filed Jan. 6, 2003; U.S. Provisional Patent Application No. 60/438,138, filed Jan. 6, 2003; and U.S. Provisional Patent Application No. 60/438,119, filed Jan. 6, 2003.

### BACKGROUND

The present inventions relate to a battery management system for a vehicle. The present inventions more specifically relate to a system for monitoring and controlling a condition of a vehicle battery system.

Batteries for use in vehicles or other applications (e.g., lead-acid batteries for use in starting, lighting, and ignition applications, commercial batteries, marine batteries, industrial batteries, etc.) are connected to a number of electrical loads. The vehicle may have a number of systems and subsystems comprising one or more components powered by the battery. For example, a battery may be connected to a vehicle air conditioning system, power door lock system, power window system, and/or any of a variety of other electrical loads. Under various circumstances, it may be desirable to monitor and/or control the battery (e.g., to manage the state of charge of the battery, etc.).

It would be advantageous to provide an improved system for monitoring, controlling, and/or managing a battery or a number of batteries (referred to hereafter as a “battery management system”). It would also be advantageous to provide a battery management system that monitors and controls a condition of the battery in response to an input signal such as the voltage of the battery and/or a condition of the electrical system of a vehicle. It would further be advantageous to provide a battery management system that selectively disconnects and reconnects the loads of an electrical system of a vehicle in response to a condition of the battery and/or a condition of the loads of the electrical system of the vehicle. It would further be advantageous to provide a battery management system that disconnects a battery from a plurality of loads (e.g., “nonessential loads”) of an electrical system of a vehicle and inhibits disconnection from “essential” loads. It would further be advantageous to provide a battery management system that disconnects a load when the state of charge of the battery is less than a pre-selected value. It would further be advantageous to provide a battery management system including a device configured to selectively disconnect the battery from the plurality of loads when the use of a vehicle is determined to be unauthorized (e.g., based on the location of the vehicle, the speed of the vehicle, the time of use of the vehicle, etc.). It would further be advantageous to provide a battery management system that selectively disconnects a plurality of loads from a battery based on a determination that an impact or collision has occurred. It would further be advantageous to provide a battery management system that disconnects a load of the battery in the event that the load fails.

### SUMMARY

The present invention relates to a method for managing a battery system for a vehicle having components and systems that includes at least one battery and that is configured to provide power to a plurality of electrical loads comprising. The method includes receiving an input signal representative of a condition of one of the components of one of the systems provided in a vehicle. The method also includes comparing the input signal with at least one parameter to determine whether the condition indicates that at least one of the plurality of electrical loads should be disconnected from the at least one battery. The method further includes disconnecting at least one of the plurality of electrical loads from the at least one battery according to a predetermined hierarchy if the input signal when compared to the parameter indicates that at least one of the plurality of electrical loads should be disconnected from the at least one battery.

The present invention also relates to a system for managing a battery system including at least one battery provided in a vehicle having a plurality of systems and components and configured to provide power to a plurality of electrical loads. The system comprises a control program for comparing an input signal representative of a condition of a component of a system provided in a vehicle to a parameter for the component and for providing an output signal to disconnect at least one of the plurality of electrical loads from the at least one battery according to a predetermined hierarchy if the input signal when compared to the parameter indicates that at least one of the plurality of electrical loads should be disconnected from the at least one battery.

The present invention also relates to a control system for a vehicle that includes a battery system comprising at least one battery and a plurality of electrical loads configured to receive power from the battery system. The control system also includes a switch for selectively electrically connecting at least one of the plurality of electrical loads to the battery system and a device for providing an output signal to the switch to disconnect the at least one of the plurality of electrical loads from the battery system according to a predetermined hierarchy. The device is configured to receive an input signal representative of a condition of a component of the vehicle and to compare the input signal to a parameter. The device is configured to provide the output signal if the input signal when compared to the parameter indicates that the at least one of the plurality of electrical loads should be disconnected from the battery system.

### BRIEF DESCRIPTION OF THE DRAWINGS

FIG. 1A is a schematic block diagram of a control system for a vehicle having a battery management system according to an exemplary embodiment.

FIG. 1B is a schematic block diagram of the control system of FIG. 1A according to another exemplary embodiment.

FIG. 2 is a flow diagram of a routine for the battery management system of FIG. 1A according to an exemplary embodiment.

FIG. 3 is a flow diagram of a routine for the battery management system of FIG. 1A according to another exemplary embodiment.

FIG. 4 is a flow diagram of a routine for the battery management system of FIG. 1A according to another exemplary embodiment.

FIG. 5 is a flow diagram of a routine for the battery management system of FIG. 1A according to another exemplary embodiment.

FIG. 6 is a flow diagram of a routine for the battery management system of FIG. 1A according to another exemplary embodiment.

FIG. 7 is a flow diagram of a routine for the battery management system of FIG. 1A according to another exemplary embodiment.

### DETAILED DESCRIPTION OF THE PREFERRED AND EXEMPLARY EMBODIMENTS

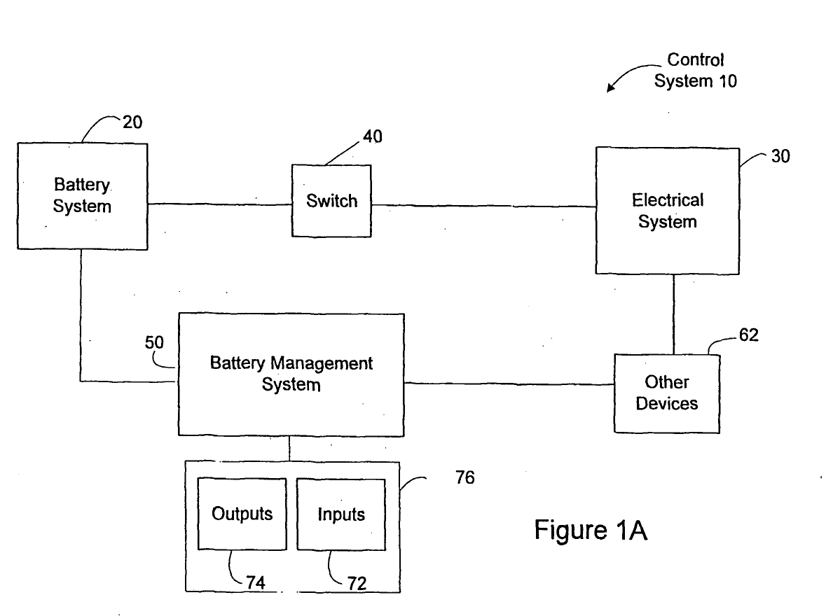

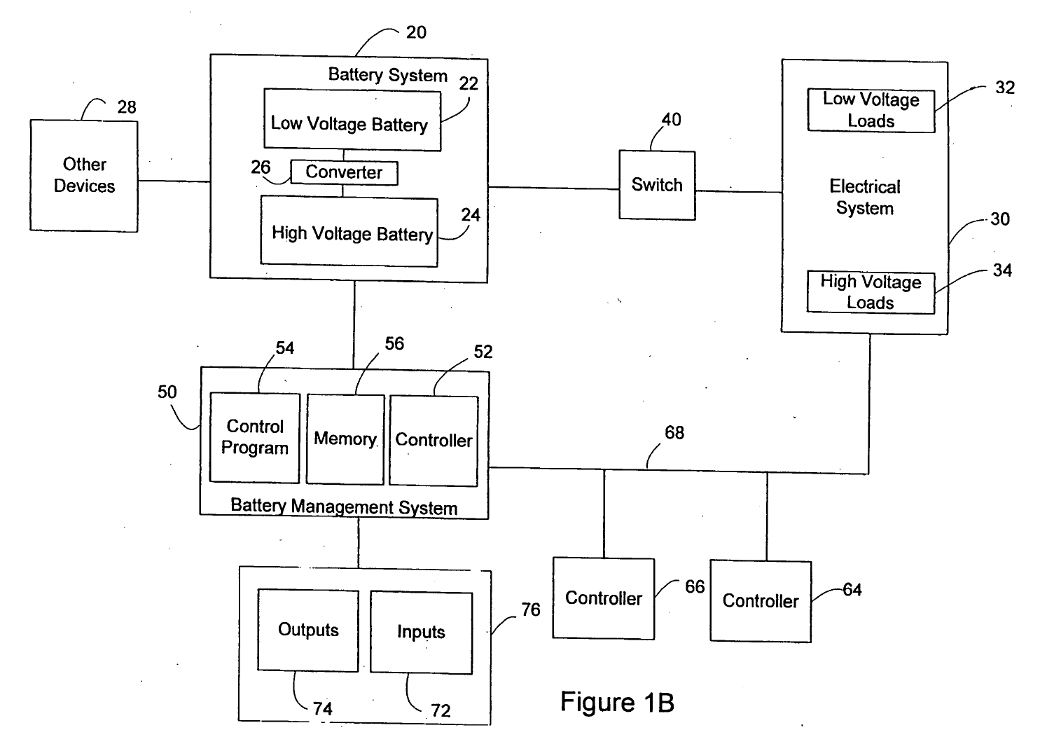

FIG. 1A shows a schematic block diagram of a control system 10 for a vehicle such as an automobile according to an exemplary embodiment. As shown in FIG. 1A, a battery system 20 including one or more batteries powers or energizes loads of an electrical system 30 of the vehicle. A battery management system or device 50 provides output signals 74, such as a signal to open and close a device or switch 40 to selectively connect and disconnect battery system 20 from one or more loads of electrical system 30.

According to another exemplary embodiment as shown in FIG. 1B, battery system 20 comprises a battery such as a low voltage battery 22 (e.g., 12V, 14V, etc.) for low voltage loads 32 of electrical system 30. Battery system 20 also comprises a battery such as a high voltage battery 24 (e.g., 24V, 36V, 42V, etc.) for high voltage loads 34 of electrical system 30 according to the exemplary embodiment as shown in FIG. 1B. The battery system may also include more than one battery according to other exemplary embodiments.

The loads of electrical system 30 comprise any module or device (e.g., system, subsystem, component, etc.) of the vehicle that is powered by battery system 20. The high voltage loads may include a vehicle starter, ignition, fuel pump, alternator, generator, steering system, braking system, etc. according to any preferred or exemplary embodiment. The low voltage loads may include a lighting system, heating and cooling system, air conditioning system, accessory such as radio, windshield washing system, adapter outlet, cigarette lighter, etc. according to any preferred or exemplary embodiment.

A converter 26 such as a DC-to-DC converter associated with low voltage battery 22 and high voltage battery 24 is electrically connected to low voltage battery 22 and high voltage battery 24 as shown in FIG. 1B. Converter 26 may be configured to accept an input voltage (e.g., from an alternator, low voltage battery, high voltage battery, reserve or auxiliary battery, etc.) to produce an output voltage to charge low voltage battery 22 and/or high voltage battery 24 according to any preferred or exemplary embodiment.

Other devices 28 may be used to charge battery system 20 and/or power the loads of electrical system 30 according to an exemplary embodiment as shown in FIG. 1B. Other devices 28 may comprise an alternator for recharging battery system 20 according to any preferred or exemplary embodiment. Other devices 28 may also comprise a reserve or auxiliary battery for powering the loads (e.g., in the event that the battery system does not have sufficient power to energize the loads).

Switch 40 closes an electric circuit to connect and energize the loads of electrical system 30 according to an exemplary embodiment as shown in FIG. 1A. While switch 40 is shown in FIG. 1B as a single switch, switch 40 may comprise any number of switches (e.g., one switch for each load, etc.). Each load (or group of loads) of the electrical system is associated with a switch (or switches) according to an exemplary embodiment (e.g., each load may have its own associated switch for selectively connecting and disconnecting the load from the battery system). Battery management system 50 provides an output signal 74 to signal switch 40 to open to disconnect certain loads from battery system 20, and to close to reconnect (or connect) certain loads to battery system 20.

Input signals 72 representative of a condition or state of battery system 20 or electrical system 30 (or electrical loads, systems, and/or components of electrical system 30) are provided to battery management system 50 by sensors associated with battery system 20 or electrical system 30: Input signals 72 may also be provided to battery management system 50 by other devices 62 such as a controller or computing device of the vehicle. Input signals 72 may also be provided directly to battery management system 50 through a user interface 76 or otherwise acquired (e.g., RF signal).

Input signals 72 may also be provided to battery management system 50 by a network 68 having a vehicle controller 64 and a controller area network (CAN) controller 66 as shown in FIG. 1B. Network 68 may comprise a CAN network and/or CAN bus according to an exemplary embodiment, and may comprise other suitable networks for providing information about the loads (such as a J1850 VPW network, ISO9141/Keyword 2000 network, etc.) according to various exemplary embodiments. The battery management system may include an input/output (I/O) port for the exchange of information with the network according to an exemplary embodiment.

According to an exemplary embodiment in which a CAN bus is utilized by battery management system 50, a variety of information may be obtained as inputs for the battery management system. For example, the CAN bus may receive signals relating to the vehicle power train (e.g., engine, gears, anti-lock braking system), vehicle body (e.g., door(s), roof and/or sunroof, seat(s), climate control, computer), multimedia equipment (e.g., radio, CD changer, navigation system, phone) and/or any of a variety of other input signals.

Battery management system 50 comprises a controller 52 for running a control program 54 that is implemented by software, hardware, firmware, or combinations thereof. Control program 54 may reside in a memory 56 or in hardware. Control program 54 comprises routines (e.g., programs, algorithms, logic, sequence of steps, calculations, etc.) using input signals 72 to provide output signals 74. For example, input signals 72 representative of a condition of the loads of electrical system 30 (e.g., load “on” or “off,” speed of the vehicle, temperature of a component, etc.) or a condition of the battery system (e.g., voltage, current, resistance, temperature, etc.) may be made available to battery management system 50 as shown in FIGS. 1A and 1B.

Battery management system 50 provides output signals 74 based on input signals 72. One type of output signal 74 provided by battery management system 50 includes a signal to open and close switch 40 to disconnect and reconnect certain loads of electrical system 30 from battery system 20. Another type of output signal 74 includes information or signals representative of a condition of battery system 20 that may be provided by battery management system 50 to another vehicle system (e.g., vehicle controller, communications network, etc.).

Another type of output signal 74 includes information or signals representative of a condition of battery system 20 that are provided to a display of user interface 76. The information may be displayed on a screen (such as a report) or by an indicator (such as a light or LED). The output signal may also be an audible signal according to an exemplary embodiment. The audible signal is perceptible to the human ear when the engine of the vehicle is running (e.g., greater than about 110 dB), or about 10 seconds after the engine is not running (e.g., greater than about 90 dB) according to an exemplary embodiment.

Referring to FIG. 1A, a sensor of battery management system 50 monitors a condition or state of battery system 20 and/or the loads of electrical system 30 of the vehicle. The sensor provides input signals 72 to battery management system 50 that are representative of such condition. Input signals 72 may also be provided to battery management system 50 by other devices 62 such as vehicle controller 64 or CAN controller 66 on network 68 as shown in FIG. 1B.

A routine of battery management system 50 uses input signals 72 provided by the sensor or otherwise acquired. Based on a determination made by the routine, battery management system 50 provides output signals 74 intended to manage operation of battery system 20. For example, output signals 74 may comprise signals to open and close switch 40 to disconnect and reconnect certain loads of electrical system 30 with battery system 20 (e.g., battery “management”). Output signals 74 may also comprise a signal to charge, discharge, condition, recondition, or otherwise service the battery system according to exemplary embodiments.

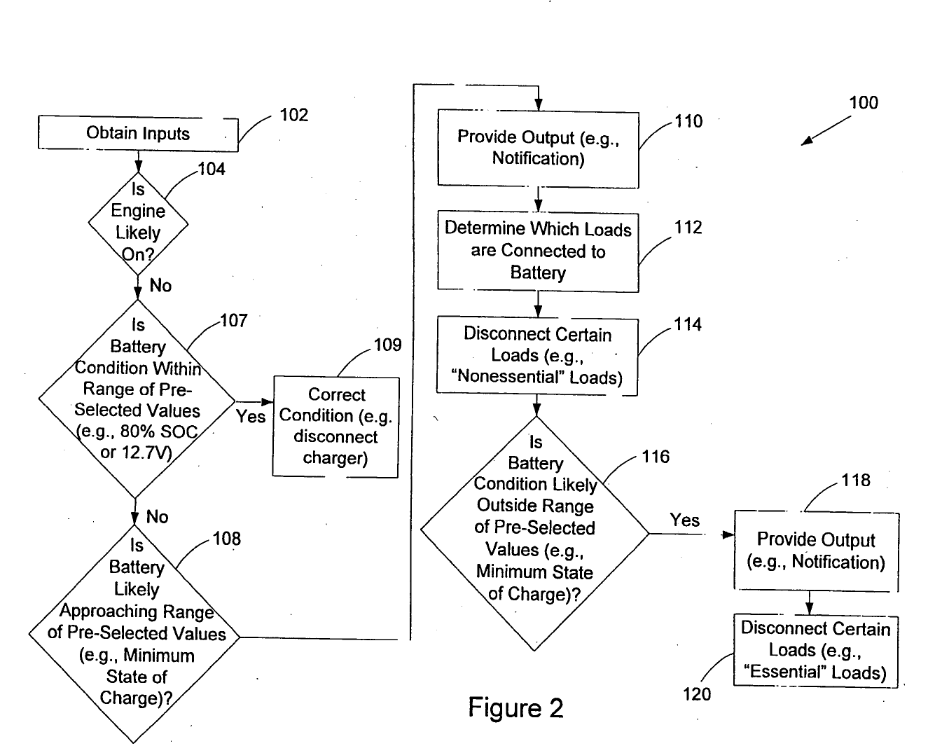

FIG. 2 shows a flow diagram for routine 100 according to an exemplary embodiment. Routine 100 is followed by battery management system 50 to make a determination whether to disconnect battery system 20 from certain loads of electrical system 30 (see steps 114 and 120) when the engine of the vehicle is not likely “on” or running (see step 104). The determination whether to disconnect battery system 20 from the loads is based on a condition or state of battery system 20 and/or the loads of electrical system 30.

Routine 100 may assist in maintaining a certain state of charge of battery system 20. Routine 100 may also assist in inhibiting the complete discharge of battery system 20, which could occur if the vehicle is stored for a long period or if a load draws an excessive or prolonged current from battery system 20. By disconnecting certain loads, a state of charge of the battery system is maintained for powering certain other loads (e.g., vehicle starter, ignition, etc.).

Referring to FIG. 2, one or more input signals 72 representative of a condition of battery system 20 are provided to battery management system 50 (step 102). The input signals are provided by a sensor such as a voltage or current sensor according to an exemplary embodiment, and may also be provided by other devices 62 or otherwise acquired according to various exemplary embodiments. The input signal may be an instantaneous value according to an exemplary embodiment. The input signal may also be a combination of values over time according to other exemplary embodiments.

For example, one or more input signals 72 (or a combination of input signals) may indicate whether the engine of the vehicle is likely “on” or “off.” Battery management system 50 compares input signals 72 to a known or pre-selected value or parameter (e.g., stored in memory 56). Battery management system 50 then makes a determination whether the engine is likely running or “on” (step 104). If the battery management system makes a determination that the engine is likely “on,” then routine 100 continues to obtain input signals 72 relating to whether the engine is likely “on” (step 102).

If battery management system makes a determination that the engine is not likely “on,” then battery management system 50 identifies a condition of battery system 20. Input signals 72 are representative of the state of charge (“SOC”) of battery system 20 according to an exemplary embodiment. The state of charge may be obtained by monitoring the voltage of a battery as a function of time (and adjusting for temperature of the battery or other conditions) according to an exemplary embodiment.

Battery management system 50 then makes a determination whether a condition of the battery (e.g., state of charge, voltage, etc.) is within a range of pre-selected values or parameters (e.g., at least about eighty percent (80%) charge, which corresponds to about 12.2V to about 12.7V for a 12V battery, etc.) (step 107). If so, battery management system 50 provides an output signal 74, which may include disconnecting the battery from a charging device, bypassing a charging circuit, reducing the voltage of the battery, etc. according to various exemplary embodiments (step 109).

Battery management system 50 then makes a determination whether the state of charge of battery system 20 is within a range of pre-selected values (step 108) such as a minimum state of charge in the range of about 12.2V to about 12.7V for a 12V battery. If the state of charge of battery system 20 is not outside a range of pre-selected values (e.g., greater than about 12.2V or about fifty percent (50%) state of charge of a 12V battery), then further input signals 72 relating to whether the engine is “on” are obtained (step 102). If the state of charge is outside a range of pre-selected values, then the battery management system makes a determination that the state of charge of the battery system is approaching a state of charge that may not support all the loads of the electrical system of the vehicle and an output signal or notification is provided (step 110).

Battery management system 50 also makes a determination of which loads (if any) are “on,” drawing current, or otherwise connected to battery system 20 (step 112). The battery management system can make such determination by, for example, querying the vehicle communications system or CAN bus, evaluating the various available input signals, correlating measured signals or loads to an observed effect on the system (e.g., headlights may produce a known load when “on” and the presence of such a load can be detected and/or measured to determine if the headlights are “on”), selectively disconnecting and reconnecting certain loads and measuring the changes in voltage (e.g., to correlate and/or determine the effect), etc. Battery management system 50 then provides output signal 74 to open switch 40 to disconnect battery system 20 from certain loads designated as “nonessential” or “primary” loads of electrical system 30 (step 114) to maintain a certain state of charge of battery system 20.

The loads designated as “nonessential” loads comprise loads that are not necessary for starting the vehicle. Examples of loads designated as “nonessential” loads comprise an adapter outlet (e.g., cigarette lighter) for connection to accessories (e.g., computing devices), entertainment systems (e.g., radio, audio-visual devices, CD player, DVD player, video systems, etc.), seating positioning devices, passenger compartment climate control systems (e.g., air conditioner, heaters, fans, etc.), interior lighting systems (e.g., dome light, overhead lighting, reading light, etc.), etc.

The loads are disconnected from the battery system according to a pre-selected hierarchy or sequence according to an exemplary embodiment. Disconnection of the loads according to the hierarchy permits the battery system to power certain loads without powering certain other “nonessential” or less important loads. According to the hierarchy for disconnecting the loads from the battery system, loads designated as “nonessential” loads are disconnected from the battery system before loads designated as “essential” loads are disconnected from the battery system according to an exemplary embodiment.

According to an exemplary embodiment, each of the loads designated as “nonessential” loads is disconnected from the battery system according to a pre-selected hierarchy. Adapter outlets are disconnected from the battery system before entertainment systems are disconnected from the battery system. Entertainment systems are disconnected from the battery system before seating position devices are disconnected from the battery system. Seating position devices are disconnected from the battery system before passenger compartment climate controls are disconnected from the battery system. Passenger compartment climate controls are disconnected from the battery system before interior lighting systems are disconnected from the battery system. According to other exemplary embodiments, any of a variety of hierarchies may be utilized to provide an order or sequence for disconnecting loads of the battery.

Referring further to FIG. 2, the battery management system 50 next makes a determination whether a condition of battery system 20 (such as the state of charge of battery system 20 according to an exemplary embodiment) is within a range of pre-selected values (step 116). If the state of charge of battery system 20 is not within a range of pre-selected valued (e.g., greater than about fifty percent (50%) state of charge), then further input signals 72 relating to whether the engine is “on” are obtained (step 102).

If the state of charge of battery system 20 is within a range of pre-selected values (e.g., less than about fifty percent (50%) state of charge), then an output signal or notification is provided (step 118). Loads designated as “essential” loads are then disconnected from the battery. Loads designated as “essential” loads comprise loads that are necessary for starting or using the vehicle. Loads designated as “essential” loads may comprise the vehicle starter, fuel pump, lighting, steering, headlights, defroster, windshield wipers, etc. according to an exemplary embodiment (step 120). Loads designated as “essential” loads are disconnected from the battery before other loads that are associated with servicing or assistance of the vehicle such as hazard lights, brake lights, door and window locks, etc., which remain connected to the battery according to an exemplary embodiment. According to another exemplary embodiment, one or more of these loads may also be disconnected from the battery system in the event that the state of charge of the battery reaches a predetermined threshold.

The loads of electrical system 30 remain disconnected from battery system 20 until a command or an output signal representative of a designated or predetermined condition to reconnect one or more of the loads is provided or otherwise obtained by battery management system 50. Such input signal may include a signal provided by a sensor that an attempt is made to start the vehicle (e.g., actuation of a “key on” switch indicating that an attempt is being made to start the vehicle, activation of a door lock, key fob, vibration indicator, door open sensor, headlamp on sensor, etc.) according to any preferred or exemplary embodiments. Such input signal may also include manual actuation of a system switch (e.g., to service the vehicle, charge the battery, etc.) according to an exemplary embodiment. Upon receiving such input signal, battery management system 50 provides an output signal to open switch 40 to reconnect all or certain loads to battery system 20.

After the loads are disconnected from the battery system (see steps 114 and 120), the battery management system may prevent restarting of the vehicle according to an exemplary embodiment. For example, the battery management system may provide an output signal to close a switch to connect a resistor to the alternator, thereby pulling the alternator voltage to ground to disable the engine (e.g., a controlled stalling of the engine) according to another exemplary embodiment. The battery management system may also provide an output signal to deactivate the electric valves or injectors of the engine according to another exemplary embodiment.

An output signal such as a notification may be provided by battery management system 50 (see steps 110 and 118) when a condition of battery system 20 is not within a range of pre-selected values (see steps 108 and 116) or when certain loads are disconnected from battery system 20 (see steps 114 and 120). The output signal could include an audible or visual indicator (e.g., warning, alarm, etc.) relating to the status of the battery system or the electrical system of the vehicle according to any exemplary or preferred embodiment. The output signal may be sent by radio frequency according to an exemplary embodiment. According to another exemplary embodiment, the output signal may be sent to a vehicle communication system such as a CAN bus. According to other exemplary embodiments, the output signal may be sent by other means.

Referring further to FIG. 2, battery management system 50 compares input signals 72 to a range of pre-selected values associated with known scenarios in which the engine of the vehicle is known to be “off” (see step 104). According to an exemplary embodiment, a sensor monitors a “secondary” voltage signal representative of the all the loads of the electrical system of the vehicle over time so that the battery management system may make a determination whether the engine of the vehicle is likely “on” or “off.” The “secondary” voltage signal corresponds to the “noise” or random and persistent disturbance that obscures or reduces the clarity of a “primary” voltage signal provided by the loads of the electrical system of the vehicle according to an exemplary embodiment. The “secondary” voltage signal is represented by an AC voltage signal associated with a DC voltage signal according to an exemplary embodiment.

The “secondary” voltage signal is sampled over a pre-selected period (e.g., 40 voltage readings taken every 12 milliseconds) according to an exemplary embodiment. The difference between the maximum “secondary” voltage value and the minimum “secondary” voltage value of the sample is referred to as the “ripple” (also referred to as the AC voltage variation). The battery management system makes a determination whether the “ripple” is within a range of pre-selected values (e.g., less than about 40 mV). If the “ripple” is not within a range of pre-selected values, then the battery management system 50 makes a determination that the loads associated with the engine of the vehicle (e.g., starter, ignition, fuel pump, etc.) are “on” and that the engine of the vehicle is likely “on.” If the “ripple” is within a range of pre-selected values, then the controller makes a determination that the loads associated with the engine of the vehicle are “off” and that the engine of the vehicle is likely “off.”

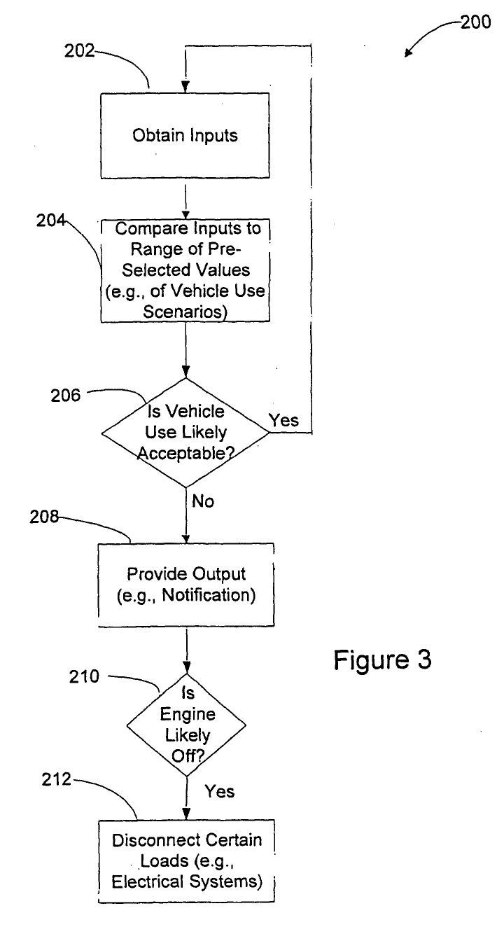

FIG. 3 shows a flow diagram for a routine 200 according to another exemplary embodiment. Routine 200 is followed by battery management system 50 to make a determination whether to disconnect battery system 20 from certain loads of electrical system 30 (see step 212). The determination whether to disconnect battery system 20 from the loads is based on whether use of the vehicle is likely authorized (e.g., acceptable to the owner of the vehicle) (see step 206).

Disconnection of the loads according to a predetermined hierarchy may inhibit theft or other unauthorized use of the vehicle. Such unauthorized use may include use of the vehicle in an unauthorized location or at an unauthorized time. Such unauthorized use may also include misuse of the vehicle such as exceeding a pre-selected value (e.g., maximum speed limit).

Referring to FIG. 3, input signals 72 representative of a condition of use of the vehicle are provided to battery management system 50 (step 202). Input signals 72 are provided by a sensor according to an exemplary embodiment, and may also be provided by other devices 62 or otherwise acquired according to an exemplary embodiment. The input signal may be an instantaneous value according to another exemplary embodiment. The input signal may also be a combination of values over time according to other exemplary embodiments.

Referring further to FIG. 3, battery management system 50 compares input signals 72 to a known or pre-selected value or parameter of a known vehicle use scenario (step 204). The pre-selected value is stored in memory 56 of battery management system 50 according to an exemplary embodiment.

Input signals 72 (or a combination of inputs) are representative of a condition relating to whether the vehicle is likely in use according to an exemplary embodiment. Battery management system 50 makes a determination whether input signals 72 are within a range of pre-selected values or parameters to determine whether use of the vehicle is likely authorized (see steps 204 and 206). If input signals 72 are within a range of pre-selected values, then routine 200 continues to obtain input signals 72 representative of a condition of use of the vehicle (step 202).

If input signals 72 are not within a range of pre-selected values or parameters, then battery management system 50 provides an output signal or notification (e.g., representative that the use of the vehicle is unauthorized) (step 208). The output signal could comprise an audible or visual indicator (e.g., warning, alarm, etc.) relating to the use of the vehicle according to any exemplary or preferred embodiment. The notification may be provided to a vehicle assistance provider or other individual or system in the form of an emergency call (e.g., an automated telephone call) or other messaging such as a numeric page, text message, e-mail provided by a communications system (e.g., cellular, digital, etc.) according to an exemplary embodiment. The notification may also provide information relating to the location of the vehicle such as provided by a global positioning system (GPS) according to another exemplary embodiment.

As shown in FIG. 3, input signals 72 are compared to a range of pre-selected values of scenarios relating to unauthorized use of the vehicle (step 204) to determine whether use of the vehicle is likely authorized (or acceptable to the owner) (step 206). One scenario indicating unauthorized use includes determining the position or location of the vehicle according to an exemplary embodiment. If the position (as provided by a sensor such as GPS or radio frequency (RF) position device) is outside of a pre-selected location range (e.g., stored in memory 56 of battery management system 50) such as outside the boundaries of a state or outside a pre-selected number of miles from a central location, then the vehicle use is likely unauthorized. The pre-selected location range may be based on pre-selected boundaries or map locations, such as borders or streets, which may be entered by a user or stored based on past driving patterns of the vehicle. The pre-selected location range may also be determined by selecting a radius or other boundary shape around a particular central location according to another exemplary embodiment. Such location could be selected, for example, by acquiring the GPS or radio frequency (RF) position of the vehicle when a driver provides an input upon exiting the vehicle through user interface 76 such as a key fob.

Another scenario indicating unauthorized use of the vehicle includes the distance the vehicle has traveled over time (or the duration a vehicle has been used) according to another exemplary embodiment. An odometer and a clock may provide such input signals. The battery management system makes a determination that use of the vehicle is likely unauthorized if the inputs indicate that the vehicle has traveled a distance greater than a pre-selected distance over a pre-selected period of time, or has been in operation for longer than a pre-selected time (e.g., an unauthorized trip of 500 miles in a single day, an unauthorized 5 hour trip, etc.) according to an exemplary embodiment.

Another scenario indicating unauthorized use of the vehicle includes the speed the vehicle has traveled according to another exemplary embodiment. A speedometer may provide such input signals. The battery management system makes a determination that use of the vehicle is likely unauthorized if the inputs indicate that the vehicle has traveled at speeds greater than a pre-selected speed (e.g., a speed greater than about 85 miles per hour) or greater than the maximum speed limit on a particular road (e.g., GPS and/or other systems may be utilized to determine the location of the vehicle and the speed limit for the particular road) according to other exemplary embodiments.

Another scenario indicating unauthorized use of the vehicle includes the time at which a vehicle is operated according to another exemplary embodiment. A clock may provide such input signals. The battery management system makes a determination that use of the vehicle is likely unauthorized if the inputs indicate that the vehicle is operated during an unauthorized time (e.g., operation at 3 a.m.) according to an exemplary embodiment.

Referring further to FIG. 3, battery management system 50 compares input signals 72 to a range of pre-selected values associated with known scenarios in which the engine of the vehicle is known to be “off” (see step 210). According to an exemplary embodiment, a sensor monitors a “secondary” voltage signal representative of the all the loads of the electrical system of the vehicle over time so that the battery management system may make a determination whether the engine of the vehicle is likely “on” or “off,” as described above with respect to FIG. 2.

According to other exemplary embodiments, the battery management system may make a determination whether the engine is likely “on” or “off” based on other input signals, combinations of inputs and/or other pre-determined scenarios. The battery management system may make a determination that the engine is likely “on” if a sensor associated with a tachometer provides an input signal representative of the relation of gears associated with the engine or alternator of the vehicle according to another exemplary embodiment. The battery management system may make a determination that the engine is likely “on” if a sensor associated with an accelerometer provides an input signal representative of acceleration of the vehicle, or if a sensor associated with a speedometer or global positioning system (GPS) provides an input signal representative of movement of the vehicle, according to another exemplary embodiment. The battery management system may make a determination that the engine is likely “on” if a sensor such as a “key-on switch” for connecting the loads of the electrical system to the battery system provides an input signal representative of the starter or ignition of the vehicle being turned “on” according to another exemplary embodiment. Other information relating to whether the engine or vehicle is “on” (e.g., engine on, fuel pump on, starter on, ignition on, lighting systems on, etc.) can be provided directly to the battery management system from the CAN controller or vehicle network according to other exemplary embodiments.

An output signal (such as a notification) may also be provided by battery management system 50 (steps 208 and 212) when a condition of battery system 20 is not within a range of pre-selected values (step 208) or when certain loads are disconnected from battery system 20 (steps 212). The output signal could include an audible or visual indicator (e.g., warning, alarm, etc.) relating to the status of the battery system or the electrical system of the vehicle according to any exemplary or preferred embodiment. According to another exemplary embodiment, certain loads may be disconnected according to a predetermined hierarchy when the engine is determined to be “off.”

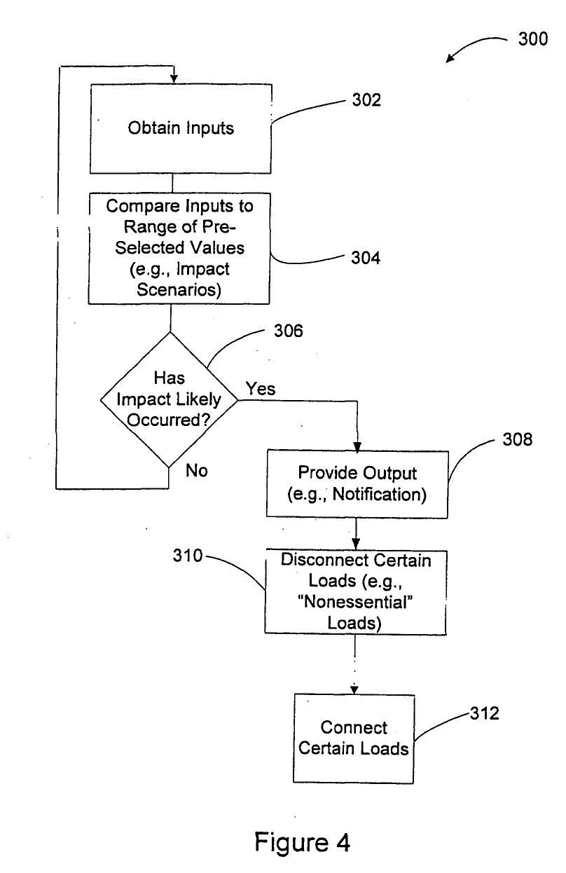

FIG. 4 shows a flow diagram for a routine 300 according to another exemplary embodiment. Routine 300 is followed by battery management system 50 to make a determination whether to disconnect battery system 20 from certain loads of electrical system 30 (see step 310). The determination whether to disconnect battery system 20 from the loads is based on a condition of battery system 20 and/or a condition of the loads of electrical system 30. The disconnection of the loads is based on whether the vehicle has been involved in a collision (i.e., whether an impact of the vehicle likely has occurred) (see step 306).

Disconnection of the loads may prevent potential damage to battery system 20 or the loads of electrical system 30. Disconnection of the loads also may prevent potential ignition of fuel or other flammable materials in the event an impact of the vehicle has likely occurred. Certain loads designated as “essential” loads may remain connected to battery system 30.

Referring to FIG. 2, input signals 72 representative of a condition of the vehicle are provided to battery management system 50 (step 302). Input signals 72 are provided by a sensor such as a voltage or current sensor according to an exemplary embodiment, and may also be provided by other devices 62 or otherwise acquired according to an exemplary embodiment. The input signals may be instantaneous, a combination of values collected over time, values calculated by algorithms, and/or values taken from look-up tables according to various exemplary embodiments.

Inputs 72 (or a combination of inputs) are representative of a condition indicating that an impact or collision of the vehicle has likely occurred. Battery management system 50 compares input signals 72 to known or pre-selected values or parameters of known impact scenarios (e.g., indicating the likelihood that the vehicle has struck or been struck by an object or been rolled to one side or over, etc.) (step 304). The pre-selected value is stored in memory 56 according to an exemplary embodiment.

Battery management system 50 makes a determination whether one or a combination of the input signals are within a range of pre-selected values to determine whether an impact of the vehicle has likely occurred (step 306). If one or a combination of input signals 72 are within a range of pre-selected values indicating that the vehicle has not been involved in an impact or collision, then routine 300 continues to obtain input signals 72 representative of a condition of the vehicle (step 302).

If input signals 72 are outside a range of pre-selected values (and indicate an impact has likely occurred), then battery management system 50 provides an output signal to open switch 40 to selectively disconnect certain loads (designated as “nonessential” loads) from battery system 20 (step 310).

Referring further to FIG. 4, certain loads (designated as “essential” loads) are connected to battery system 20 (step 312) after battery management system makes a determination that an impact has likely occurred (step 306). Loads designated as “essential” loads comprise loads associated with servicing or assistance of the vehicle such as hazard lights, brake lights, door and window locks, etc. according to an exemplary embodiment.

Battery management system 50 also provides an output signal or notification that an impact has likely occurred and/or that certain loads will be disconnected from battery system 20 (step 310). The output signal may include an audible and/or visual indicator (e.g., warning, alarm, etc.) relating to the status of the battery system or the electrical system of the vehicle according to any exemplary or preferred embodiment. The notification may be provided to a vehicle assistance provider in any suitable form of an emergency call, such as an automated telephone call or other messaging such as numeric page, text message, or e-mail provided by a communications system (e.g., cellular, digital, etc.) according to an exemplary embodiment. The notification can provide information relating to the location of the vehicle such as provided by a GPS (Global Positioning System) system according to another exemplary embodiment.

As shown in FIG. 4, input signals 72 are compared to a range of pre-selected values of impact scenarios (see step 304) to determine whether an impact of the vehicle has likely occurred (step 306) according to an exemplary embodiment. The input signals may relate to whether the vehicle has experienced a rapid deceleration based on a signal provided by a sensor or sensors (such as accelerometers) in various locations of the body of the vehicle (e.g., bumpers, fenders, interior, etc.) according to an exemplary embodiment. If the sensors provide an input signal that the vehicle has experienced rapid deceleration characteristic of an impact scenario (e.g., greater than about 15 g, greater than about 15 miles per hour over a pre-selected period such as 1 to 15 milliseconds, etc.) then the battery management system makes a determination that an impact has likely occurred according to an exemplary embodiment.

Other input signals may be obtained for comparison with the a range of pre-selected values of the impact scenarios according to other exemplary embodiments. For example, a sensor such as a pressure transducer for monitoring the pressure applied to the brakes may monitor the pressure or force per unit of area applied to the brakes (or the fluid pressure in a brake line over time). If the monitored pressure is outside a range of pre-selected values, the battery management system may determine that the brakes were “locked” or applied for a long period, which would indicate that an impact has likely occurred according to an exemplary embodiment. If a sensor (or the vehicle network) provides a signal representative of an air bag being deployed, then the battery management system may make a determination that an impact of the vehicle has likely occurred according to another exemplary embodiment.

The sensor for monitoring impact of the vehicle may comprise a ball and magnet design according to an exemplary embodiment. According to such design, a ball moves or rolls on application of a sufficient force to complete an electrical circuit by engaging two contacts according to an exemplary embodiment. The sensor for monitoring impact of the vehicle may also comprise a “level” or other device that provides a signal if the vehicle has tipped, rolled or otherwise shifted beyond 180 degrees. The sensor for monitoring impact of the vehicle may also comprise a spring band and roller design. According to such design, a roller moves on application of a sufficient force to close a contact when tension of a spring band that is overcome according to another exemplary embodiment. The sensor for monitoring impact of the vehicle may also comprise a rotating weight design. According to such design, a moves a rotor against a spring tension on application of a sufficient force to a point where contacts complete a circuit. The sensor may also comprise a mercury switch according to another exemplary embodiment.

The battery management system may utilize a combination of these scenarios (e.g., “and” combinations) to determine if an impact of the vehicle has likely occurred according to an exemplary embodiment. For example, the determination that a vehicle impact has likely occurred according to one scenario may be confirmed by another scenario (e.g., a signal indicating rapid deceleration greater than a pre-selected value and signal indicating that an air bag has been deployed).

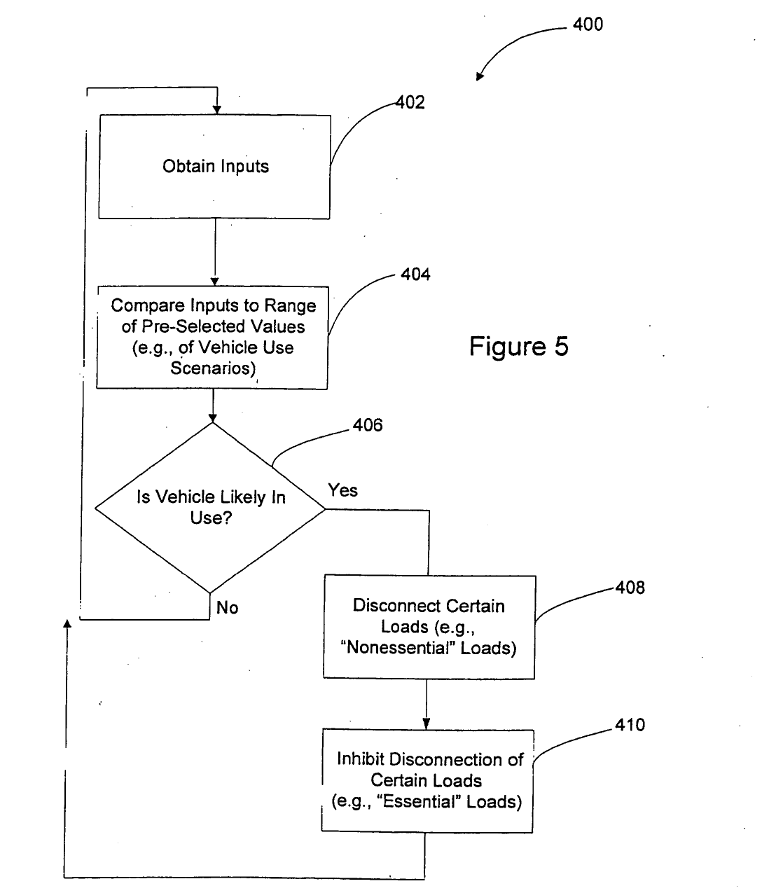

FIG. 5 shows a flow diagram for a routine 400 according to another exemplary embodiment. Routine 400 is followed by battery management system 50 to make a determination whether to disconnect battery system 20 from certain loads of electrical system 30 (see step 408) and when to maintain the connection of certain loads with battery system 20 (see step 410). The determination whether to disconnect battery system 20 from the loads is based on a condition of battery system 20 and/or a condition of the loads of electrical system 30, including whether the vehicle is likely in use.

Referring to FIG. 5, input signals 72 representative of a condition of battery system 20 or electrical system 30 are provided to battery management system 50 (step 402). Input signals 72 are provided by a sensor such as a voltage or current sensor according to an exemplary embodiment, and may also be provided by other devices 62 or otherwise acquire according to an exemplary embodiment.

Input signals 72 are representative of a condition of whether the engine of the vehicle is likely “on” or “off,” according to an exemplary embodiment. Battery management system 50 compares input signals 72 to a known or range of pre-selected values or parameters (e.g., stored in memory 56) (step 404). Battery management system 50 then makes a determination whether the engine is likely running or “on” (step 406). If the battery management system makes a determination that the engine is likely “on,” then input signals 72 relating to whether the engine is on are obtained (step 402).

If battery management system makes a determination that the engine is not likely “on,” then battery management system 50 makes a determination whether certain loads (e.g., “nonessential” loads) should be disconnected from battery system 20. For example, loads designed as “nonessential” loads are disconnected from battery system 20 if the state of charge of battery system 20 is not within a range of pre-selected values (e.g., less than about 12.2V or less than about 50 percent state of charge of a 12V battery) according to an exemplary embodiment. Battery management system 50 then commands switch 40 to disconnect battery system 20 from certain loads designated as “nonessential” loads of electrical system 30 (step 408) according to a predetermined hierarchy to maintain a certain state of charge of battery system 20.

Battery management system 50 also inhibits disconnection of battery system 20 from certain loads designated as “essential” of loads of electrical system 30 (step 400). Inhibiting the disconnection of the “essential” loads may be accomplished by overriding any other command to battery management system to disconnect such loads. (A switch may be manually activated to disconnect such “essential” loads from the vehicle when the vehicle is in use according to an exemplary embodiment.) Examples of loads designated as “essential” loads comprise loads that are necessary for starting or driving the vehicle such as the vehicle starter, fuel pump, lighting, steering, defroster, windshield wipers, hazard lights, brake lights, door and window locks, etc. according to an exemplary embodiment.

Referring further to FIG. 5, battery management system 50 compares input signals 72 to a range of pre-selected values associated with known scenarios in which the engine of the vehicle is known to be in use or the engine of the vehicle is known to be “on” (see step 404). The input signals may relate to whether an occupant is in the vehicle, which may be indicated by an input signal provided by a sensor (e.g., pressure transducer located in the seat of the vehicle) according to an exemplary embodiment. If the sensors provide an input signal representative of an occupant being in the vehicle, then the battery management system makes a determination that the vehicle is likely in use according to an exemplary embodiment (step 406).

Other input signals may be provided for comparison with the scenarios according to other exemplary embodiments. For example, a switch or sensor may monitor whether a door of the vehicle is open, which would indicate that the vehicle is in use according to an exemplary embodiment. A sensor (or vehicle network) may provide a signal representative that an interior light of the vehicle is “on,” which would indicate that the vehicle is in use according to an exemplary embodiment. A sensor (or vehicle network) may provide a signal representative that the vehicle is in a gear other than “park” or that the clutch of the vehicle is engaged, which would indicate that the vehicle is in use according to an exemplary embodiment. Other sensors may provide other signals representative of a condition of a vehicle system that indicate that the vehicle is likely “on,” such as a sensor that monitors vehicle oil pressure, the position of the ignition key switch, vehicle movement, vehicle tachometer, air speed, vibration, acceleration, deceleration, position (e.g., GPS), and others. Such other sensors may be used in addition to or in place of the sensors described above.

Referring further to FIG. 5, battery management system 50 compares input signals 72 to a range of pre-selected values associated with known scenarios in which the engine of the vehicle is known to be “off” or not likely in use (see step 406). According to an exemplary embodiment, a sensor monitors a “secondary” voltage signal representative of the all the loads of the electrical system of the vehicle over time so that the battery management system may make a determination whether the engine of the vehicle is likely “on” or “off,” as described above with respect to FIG. 2.

According to other exemplary embodiments, the battery management system may make a determination whether the engine is likely “on” or “off” based on other input signals, combinations of inputs and/or other pre-determined scenarios, as described above with respect to FIG. 3.

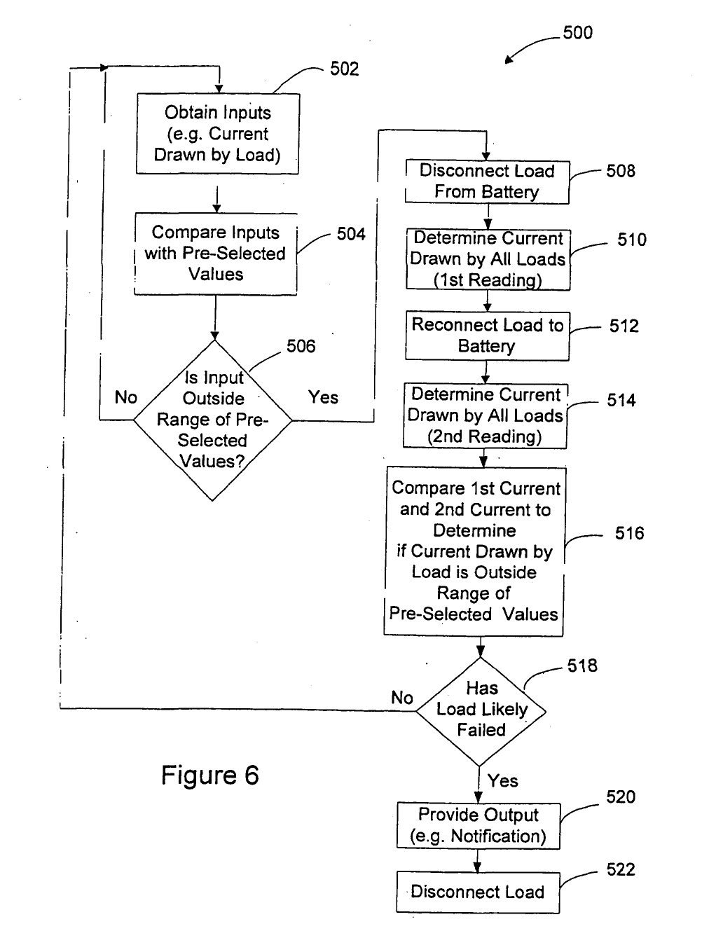

FIG. 6 shows a flow diagram for a routine 500 according to another exemplary embodiment. Routine 500 is followed by battery management system 50 to make a determination whether the loads of electrical system 30 are operating within a range of pre-selected values (see step 506). In general, this determination is made by selectively disconnecting and reconnecting certain loads of electrical system 30 with battery system 20 and measuring the change in current drawn from battery system 20. The disconnection and reconnection of the loads can assist in the determination whether a certain load has failed. Routine 500 may be run periodically such as each time the engine of the vehicle is turned “off” or at some other pre-selected time or interval.

If a load draws a current outside a range of pre-selected values or parameters, then battery management system 50 makes a determination that the load has “failed” or drawn an excessive current (see step 518). Upon making a determination that the load has failed, battery management system 50 disconnects such load from battery system 20 (see step 520) and/or provides an output signal 74 or notification that indicates the failure of the load (see step 522).

Disconnection of such load may prevent excessive current from being drawn from battery system 20 by the load, which may maintain a certain state of charge of battery system 20. Disconnection of the failed load also may inhibit the load from being damaged by excessive current drawn from battery system 20. Disconnection of such load from battery system 20 also may also extend the useful life of battery system 20.

Referring to FIG. 6, input signals 72 representative of a condition of electrical system 30 are provided to battery management system 50 (step 502). The input signals are provided by a sensor such as a voltage or current sensor according to an exemplary embodiment, and may also be provided by other devices 62 or otherwise acquired according to an exemplary embodiment. Inputs 72 are representative of whether a load of electrical system 30 is “on,” drawing current or otherwise connected to battery system 20 according to an exemplary embodiment. The input signal may be an instantaneous value according to another exemplary embodiment. The input signal may also be a combination of values over time according to other exemplary embodiments.

Referring further to FIG. 6, battery management system 50 compares input signals 72 to a known or pre-selected range of values (step 504). The pre-selected range of values is stored in memory 56 of battery management system 50 according to an exemplary embodiment. The pre-selected range of values is the “expected” current that should be drawn by all the loads that are “on” according to an exemplary embodiment.

If input signals 72 are not within the pre-selected range of values (see step 506), then battery management system 50 provides an output signal 74 to open switch 40 to disconnect certain loads of electrical system 30 from battery system 20 (step 508). If input signals 72 are within the pre-selected range of values, then routine 500 continues to obtain inputs signals 72 representative of the current drawn from battery system 20 and/or representative of a condition of a load (step 502).

The pre-selected value or range of values are “learned” by battery management system 50 according to an exemplary embodiment. Such learning includes recording the current drawn by the loads over time from battery system 20 according to an exemplary embodiment. Initiation of a learning procedure may be commenced at a pre-selected time or event such as at installation of the battery management system or the battery system, cycling of the starter a pre-selected number of times, etc. according to any preferred or exemplary embodiment.

Learning of the expected current drawn by a load is accomplished by selectively turning each load “on” so that it draws a current or is otherwise connected to battery system 20, and then determining the current drawn from battery system 20 according to an exemplary embodiment. For example, each time the battery management system turns a certain fan “on,” a sensor (e.g., voltage or current sensor) provides a signal that the change in current drawn from the battery is about 10 amps. Thus, the battery management system records (e.g., in memory) that the pre-selected or expected current drawn by such fan is 10 amps. The battery system may record an average current or range of current values drawn by such fan over time according to an exemplary embodiment. All inputs relating to certain conditions of the loads or the battery system may be stored in memory over time for future use according to an exemplary embodiment.

The battery management system may also record the changes in current drawn from the battery when certain loads are turned “on” and “off” during routine operation of the vehicle according to an exemplary embodiment. Information relating to when a particular load is turned “on” or “off” may be provided by the vehicle network or otherwise acquired, and a sensor may monitor the change in current drawn from the battery.

Referring further to FIG. 6, if input signals 72 (i.e., the total current drawn from battery system 20 by the loads that are “on”) are not within the range of pre-selected values, then battery management system 50 provides an output signal to open switch 40 to selectively disconnect certain loads (i.e., the loads that draw a current that is not within the range of pre-selected values) from battery system 20 (see step 508). The remaining steps of routine 500 are then performed to determine if the particular load has failed (see step 518) or if the unexpected current drawn is due to another load.

After disconnection of the load from battery system 20 (step 508), battery management system 50 identifies the remaining current drawn from battery system 20 (step 510). Battery management system 50 then provides an output signal to open switch 40 to reconnect the load to battery system 20 (step 512). The current drawn from battery system 20 is then measured again (step 514). Battery management system 50 then determines the difference between the first current value (step 510) and the second current value (step 514). The result is compared to a range of pre-selected values representative of the expected current that should be drawn by the load if the load has not failed (step 516). If the difference is not within a range of pre-selected values, then battery management system 50 provides an output signal to open switch 40 to disconnect the load from battery system 20 (step 522) and/or to provide an output signal or notification (step 520). If the difference is within the range of pre-determined values, then routine 100 again obtains input signals 72 representative of the current drawn from battery system 20 and/or representative of a condition of a load (step 502).

For example, a signal may be provided to the battery management system that indicates that an interior light is the only load connected to the battery system, and that the total current drawn from the battery is 5 amps, which is within an expected or pre-selected range for the interior light (see steps 502 through 506). The battery management system then receives an input signal that a fan is turned “on.” (The battery management system can selectively disconnect each load of the electrical system and measure a change in voltage to determine which loads are “on” according to an exemplary embodiment.) When the fan is turned “on,” the current drawn from the battery system increases from 5 amps to 20 amps, indicating that the fan is drawing 15 amps. Based on the range of pre-selected values stored in memory, however, the fan is expected to draw only 4-6 amps (see steps 502 to 506).

To verify that the fan is drawing more current than expected, and to eliminate the possibility that the unexpected current drawn from the battery is due to another load, the battery management system provides an output signal to open the switch to disconnect the fan from the battery system (see step 508). The battery management system then determines the current drawn from the battery to obtain a first current reading (see step 510), which for this example is 5 amps (i.e., due to interior light being turned “on”). The battery management system then provides an output signal to close the switch to reconnect the fan to the battery system (see step 512), and makes a determination of the current drawn from the battery to obtain a second current reading (see step 514) (e.g., 20 amps).

The battery management system then makes a determination that the difference between the two current measurements is 15 amps (i.e., 20 amps when the interior light and the fan are turned “on” and 5 amps when only the interior light is turned “on”). The fan is then assigned a value of drawing about 15 amps from the battery system, which is outside the range of pre-selected values of 4-6 amps. Therefore, the battery management system makes a determination that the fan has failed (see step 518), and provides an open output signal to open the switch to disconnect the fan from the battery system (see step 520).

According to another exemplary embodiment, the routine may focus on input signals directed to particular loads of the electrical system. For example, if the input signal is representative of a low voltage provided by the alternator that is less than a pre-selected value (considering state of charge of the battery and revolutions per minute of the alternator), then the battery management system may provide an output signal or notification that the alternator has failed and the battery system will likely not be properly charged according to another exemplary embodiment. If the input signal is representative of a low voltage provided by the air conditioning system that is less outside the range of pre-selected values, then the battery management system may provide an output signal or notification that the compressor of the air conditioner has failed according to an exemplary embodiment.

If the input signal is representative of a voltage provided by the battery that is greater than that which the battery can likely accept (e.g., the battery is at 100% state of charge), then the battery management system may provide an output signal to stop charging the battery (thus providing “overcharge protection”) according to an exemplary embodiment.

The selective disconnection of loads by the battery management system for testing whether the loads have failed progresses according to a pre-selected hierarchy or sequence according to an exemplary embodiment. Once the battery management has determined that a load is “on,” loads designated as “nonessential” loads (e.g., loads that are not necessary for starting or driving the vehicle) are disconnected before loads designated as “essential” loads (e.g., loads that are necessary for assistance or servicing of the vehicle). For example, a first stage of disconnection of the loads from the battery system includes disconnection of loads designated as “nonessential” loads such as adapter outlets (e.g., cigarette lighter) for connection to accessories (e.g., computing device). A second stage of disconnection of loads from the battery system includes other loads designated as “nonessential” loads such as entertainment systems (e.g., radio, CD player, DVD player, video systems, etc.). A third stage of disconnection of the loads from the battery includes disconnection of other loads designated as “nonessential” loads such as passenger compartment climate control loads (e.g., air conditioner, heaters, fans, etc.) and seating positioning devices. A fourth stage of disconnection of the loads from the battery system includes disconnection of other loads designated as “nonessential” loads such as interior lighting systems (e.g., dome light, overhead lighting, reading light, etc.). In certain situations (such as the vehicle is likely not in use or the engine of the vehicle is likely off), a fifth stage of disconnection of loads designated as “essential” loads from the battery is accomplished. Examples of loads designated as “essential” loads comprise the vehicle starter, fuel pump, lighting, steering, defroster, windshield wipers, hazard lights, brake lights, door and window locks, etc. Other hierarchies may also be used according to various other exemplary embodiments.

An output signal such as a notification may also be provided by battery management system 50 (steps 522) when a condition of electrical system 30 is outside a range of pre-selected values (step 506) or when a load has likely failed (step 520) and will be disconnected (step 522). The output signal may include an audible or visual indicator (e.g., warning, alarm, etc.) relating to the status of the battery system or the electrical system of the vehicle according to any preferred or exemplary embodiment. The output signal may be sent by radio frequency according to an exemplary embodiment. According to another exemplary embodiment, the output signal may be sent to a vehicle communication system such as a CAN bus. According to other exemplary embodiments, the output signal may be sent by other means.

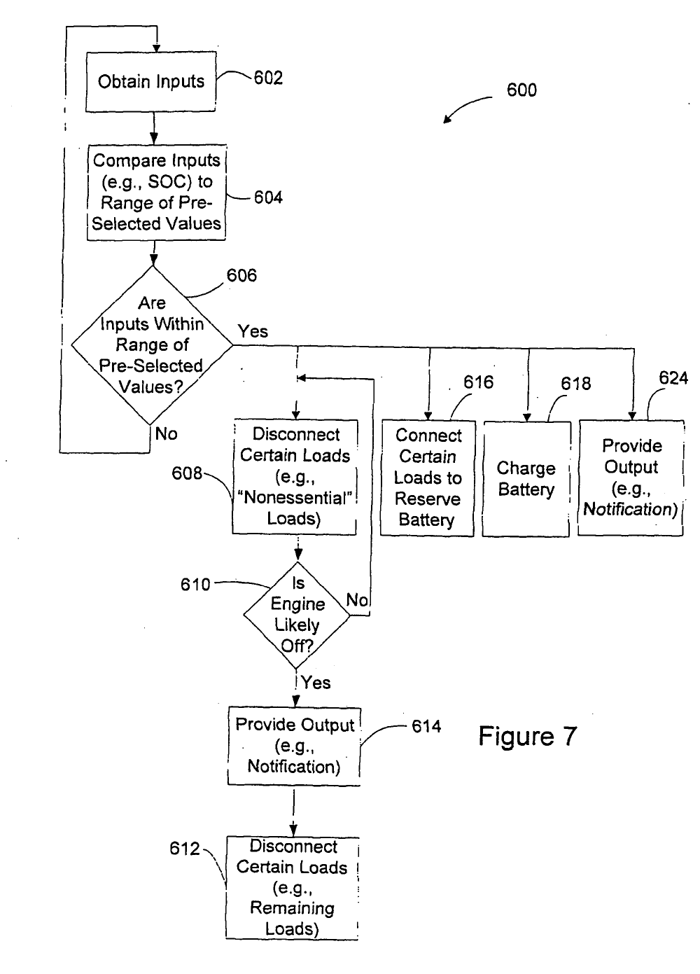

FIG. 7 shows a flow diagram for routine 600 according to another exemplary embodiment. Routine 600 is followed by battery management system 50 to make a determination whether to disconnect battery system 20 from certain loads of electrical system 30 (see steps 608 and 612). The determination of whether to disconnect battery system 20 from the loads is based on a condition or state of battery system 20 and/or the loads of electrical system 30.

Disconnection of the loads maintains a certain state of charge of battery system 20 above a pre-selected value (e.g., fifty percent 50% state of charge), for example, in the event that battery management system 50 makes a determination that battery system 20 may not have sufficient charge to power all the loads of electrical system 30. Maintenance of the state of charge above the pre-selected value can extend the time the battery system can service the loads of the vehicle before stopping to obtain service (such as recharging or replacing the battery system).

Referring to FIG. 7, input signals 72 representative of a condition of battery system 20 are provided to battery management system 50 (step 602). The inputs are provided by a sensor such as a voltage or current sensor according to an exemplary embodiment, and may also be provided by other devices 62 or otherwise acquired according to an exemplary embodiment. The input signal may be an instantaneous value according to another exemplary embodiment. The input signal may also be a combination of values over time according to other exemplary embodiments.

Input signals 72 (or a combination of input signals) are representative of the state of charge (“SOC”) of battery system 20 according to an exemplary embodiment. The state of charge may be obtained by monitoring the voltage of a battery as a function of time (and adjusting for temperature of the battery) according to an exemplary embodiment.

Referring further to FIG. 7, battery management system 50 compares input signals 72 to a known or pre-selected value or parameters (step 604). The pre-selected value is stored in memory 56 of battery management system 50 according to an exemplary embodiment. According to another exemplary embodiment, the input signals may be monitored over time to provide a database of information or values and the pre-selected range may be designated based on such monitored signals.

Battery management system 50 makes a determination whether input signals 72 are within a range of pre-selected values (or greater than a pre-selected value) (step 606). If input signals 72 are within a range of pre-selected values, then battery management system 50 provides output signal 74 to open switch 40 to selectively disconnect certain loads (e.g., “nonessential” loads) from battery system 20 (step 608). If input signals 72 are not within the range of the pre-selected values, then routine 600 continues to obtain input signals 72 representative of a condition of battery system 20 (step 602).

The state of charge of the battery system is compared to the range of the pre-selected values (e.g., a range of about 12.2V to about 12.7V for a 12V battery) (step 604) according to an exemplary embodiment. If the state of charge is less than the range of the pre-selected values (e.g., less than about 12.2V or about 50 percent state of charge for a 12V battery), then the battery management system makes a determination that the state of charge of the battery system is approaching a level that may not support all the loads of the electrical system of the vehicle. Accordingly, the battery management system provides an output signal to open the switch to disconnect certain loads designated as “nonessential” or “primary” loads from the battery system to preserve the charge of the battery system (step 608).

Referring further to FIG. 7, battery management system 50 makes a determination whether the vehicle appears to be in use (e.g., the vehicle is stored, parked, etc.), which is indicated by whether the engine of the vehicle appears to be turned “off” (step 610). If the engine of the vehicle is not likely “off,” then battery management system 50 waits until the engine of the vehicle is likely “off.” Battery management system 50 then provides an output signal to open switch 40 to disconnect certain loads (loads designated as “secondary” loads from battery system 20) (step 612).

Loads designated as “secondary” loads comprise loads of the electrical system that are not necessary for servicing or assisting of the vehicle. Loads designated as “secondary” loads may comprise the vehicle starter, fuel pump, lighting, steering, defroster, windshield wipers, etc. according to an exemplary embodiment. Certain other loads (designated as e.g., “tertiary” or “essential” loads that are associated with servicing or assisting of the vehicle such as hazard lights, brake lights, door and window locks, etc. remain connected to the battery according to an exemplary embodiment.

The loads are disconnected from the battery system according to a pre-selected hierarchy or sequence according to an exemplary embodiment. Disconnection of the loads according to the hierarchy permits the battery system to power certain loads without powering certain other loads designated as “nonessential” or less important loads. According to the hierarchy for disconnecting the loads from the battery system, “primary” loads are disconnected from the battery system before loads designated as “secondary” loads are disconnected from the battery system according to an exemplary embodiment. Loads designated as “secondary” loads are disconnected from the battery system before loads designated as “tertiary” loads are disconnected from the battery system according to an exemplary embodiment.

According to an exemplary embodiment, each of the loads designated as a “primary” load is disconnected from the battery system according to a pre-selected hierarchy. Adapter outlets are disconnected from the battery system before entertainment systems are disconnected from the battery system according to an exemplary embodiment. Entertainment systems are disconnected from the battery system before seating position devices are disconnected from the battery system according to an exemplary embodiment. Seating position devices are disconnected from the battery system before passenger compartment climate controls are disconnected from the battery system according to an exemplary embodiment. Passenger compartment climate controls are disconnected from the battery system before interior lighting systems are disconnected from the battery system according to an exemplary embodiment.

According to an exemplary embodiment, the state of charge of the battery system is continually monitored over a period. A determination is made by the battery management system whether the disconnection of the loads according to the hierarchy maintained the state of charge of the battery system above a pre-selected value (or range of values). Such maintenance of the state of charge may provide enough time for the battery system to recondition or recharge to an acceptable state of charge.

Referring further to FIG. 7, battery management system 50 compares input signals 72 to a range of pre-selected values associated with known scenarios in which the engine of the vehicle is known to be “off” (see step 610). According to an exemplary embodiment, a sensor monitors a “secondary” voltage signal representative of the all the loads of the electrical system of the vehicle over time so that the battery management system may make a determination whether the engine of the vehicle is likely “on” or “off,” as described above with respect to FIG. 2.

According to other exemplary embodiments, the battery management system may make a determination whether the engine is likely “on” or “off” based on other input signals, combinations of inputs and/or other pre-determined scenarios, as described above with respect to FIG. 3.

An output signal (such as a notification) may also be provided by battery management system 50 (steps 614 and 624) when a condition of battery system 20 is not within a range of pre-selected values (step 606) or when certain loads are disconnected from battery system 20 (steps 608 and 612). The output signal could include an audible or visual indicator (e.g., warning, alarm, etc.) relating to the status or condition of the battery system or the electrical system of the vehicle according to any exemplary or preferred embodiment.

According to another exemplary embodiment as shown in FIG. 7, routine 600 follows additional steps if input signals 72 are within a range of pre-selected values (step 606). For example, if the input signal is representative of a state of charge of battery system 20 that is greater than fifty percent (50%), then switch 40 connects battery system 20 to certain loads (e.g., loads designated as “tertiary” or “essential” loads) to other devices 28 such as a reserve or auxiliary battery (step 616). Such connection of the reserve battery may assist in maintaining the state of charge of battery system 20 or ensure that certain loads will have sufficient power (e.g., starting system, hazard lights, etc.).

Another step in routine 600 follows if input signals 22 are within a range of pre-selected values includes charging battery system 20 (step 618) according to an exemplary embodiment as shown in FIG. 7. Battery system 20 may be charged in a variety of ways according to any preferred or exemplary embodiments, including by increasing the charge provided to the battery system 20 by the alternator (step 620) or by charging battery system 20 using converter 26 (step 622).

Other steps of routine 600 may be followed according to other exemplary embodiments. For example, if the input signal is representative of a high temperature condition of the battery system that is within a range of pre-selected values, then the battery management system may provide an output signal or notification that the battery system requires cooling according to an exemplary embodiment. If the input signal is representative of a low temperature condition of the battery system that is within a range of pre-selected values, then the battery management system may provide an output signal to warm the battery system (e.g., using a heater) according to an exemplary embodiment. If the input signal is representative of a temperature increase of the battery system that is within a range of pre-selected values or greater than a pre-selected rate of increase, then the battery management system may provide an output signal that the battery system may be overcharged or overheated and may not be properly charged according to an exemplary embodiment. If the input signal is representative of an adequate state of charge of the battery system, then that battery management system may provide an output signal to prohibit charging (or overcharging) of the battery system according to an exemplary embodiment. If the input signal is representative of a low state of charge of the battery system that is not within a range of pre-selected values, then that battery management system may provide an output signal or notification to remove the battery from the electrical system for diagnostic testing according to an exemplary embodiment. If the input signal is representative of a low electrolyte level (i.e., a solution of sulfuric acid and water) in the battery system that not within a range of pre-selected value, then that battery management system may provide an output signal or notification to provide maintenance for the battery system (e.g., addition of water required) according to an exemplary embodiment.

Other input signals (e.g., relating to current, temperature, impact, speed, etc.) may be used by one or more of the routines described according to exemplary embodiments to provide other output signals (e.g., actions/responses), nonexclusive examples of which are shown in TABLE 1.

TABLE 1

| Input signals: | | Signal processing: | Action/responses |
|---|---|---|---|
| Current: | (A1) Starter draw | (1) Learning mode: | (1) Preprogram or learn the current |
| | | Archive current required to start afo temp., | profile of starter output and store in |
| | | voltage, etc. | memory. |
| | | (2) Action model: | (2) Send warning signals, e.g. starter |
| | | Detect changes in starter draw, compare with | failing, circuit breaking, etc. |
| | | current capability with the State of Charge data | (3) Disconnect battery. |
| | | in memory. | |
| | | (3) Combine signals (A1), (B1), (C3) and State | |
| | | of Charge data to determine if disconnection of | |
| | | battery to preserve starting power is necessary. | |
| | (A2) Alternator | Detect current output and determine if the | Send warning signals for failing |
| | output | output is adequate based on signals (B2), (C3) | alternator or battery not charged. |
| | | and State of Charge data. | |
| | (A3) Lights: | Determine if disconnection of battery to | Disconnect battery. |
| | Head Lights, | preserve starting power is necessary based on | |
| | Dome Lights, | rate of current draw and signals (B1), (C3) and | |
| | Displays, etc. | State of Charge data. | |
| | (A4) Electronic | Determine if disconnection of battery to | Disconnect battery. |
| | accessories | preserve starting power is necessary based on | |
| | Radio, Fans, Panel | rate of current draw and signals (B1), (C3) and | |
| | Display, Cigarette | State of Charge data. | |
| | Lighter, Catalytic | | |
| | Converter | | |
| | (A5) AC | Learn temperature afo current. Detect changes | Update current draw data. Send |
| | | and determine if the compressor is operating. | warning signals. |
| | (A6) Catalytic | Learn temperature rise afo current. Detect | Update current draw data. Send |
| | converter | changes and determine if the converter is | warning signals. |
| | | operating. | |
| Voltage: | (B1) Battery | Combine signals (A1), (A2), (A3), (A4) and | Update SOC data using the internal |
| | | (C3) to determine State of Charge of battery. | logic, send signals for failing battery. |
| | (B2) Alternator | Combine with signals (E1) and (E3) to | Send warning signals for failing |
| | output | determine if battery can be properly charged. | alternator or battery not charged. |
| | (B3) Micro | Using signals (B1), (B2) to determine if the | Activate back-up power to retain |
| | processor | processor can function properly and memory | memory and send signals for service. |
| | | not lost. | |
| | (B4) Starter cutoff | Using signals (A1, (B1), (C3) and State of | Send signals for service. |
| | | Charge to determine risk of no start. | |
| Temperature | (C1) Engine | Determine if engine temperature is within | Send warning signals for possible |
| | | range. | engine failure. |
| | (C2) Catalytic | Determine if proper temperature is reached | Delay engine start until proper |
| | converter | before start. | temperature is reached. |
| | (C3) Battery | Determine with signals (A1), (B2) and State of | Send warning signals for |
| | | Charge if the rate of temperature rise is proper. | overcharge/overheat, battery not |
| | | | charged, etc. |
| | (C4) Radiator | Determine if the temperatures of engine and | Send warning signals for possible |
| | | coolant are within range. | failure of water pump, radiator, or lack |
| | | | of coolant. |
| | (C5) Climate | Compare output signals with settings, | Send warning signals for possible |
| | control: | determine with signal (A5) if AC is operating, | causes of failure. |
| | AC, heater | or with signal (A4) if fans are operating. | |
| Impact: | (D1) Vehicle speed | Determine minimum momentum of impact. | Set threshold for disconnecting |
| | | | battery. |
| | (D2) Collision | Calculate collision momentum and determine if | Deploy proper airbags, disconnect |
| | angle (at least 1 | threshold has been exceeded. | battery. |
| | sensor at each | | |
| | corner of vehicle) | | |
| Speed: | (E1) Engine rpm | Combine with (E2) to determine if | Send warning signals. |
| | | transmission is operating. | |
| | (E2) Vehicle speed | Speeding control: determine if preset upper | Kick in cruise control and coast to the |
| | | limit is exceeded (parents can set/overwrite the | preset speed, deactivate if speed |
| | | speed limit for teenage drivers with a minimum | drops. |
| | | of, e.g., 60 mph). | |
| | (E3) Alternator | Determine with signal (B2) if alternator is | Send warning signals. |
| | rpm | operating. | |

According to other embodiments, various other input signals and/or combinations of input signals may be used.

The use of the term battery “management” or “battery management system” is not intended as a term of limitation insofar as any function relating to the battery, including monitoring, charging, discharging, recharging, conditioning, connecting, disconnecting, reconnecting, etc., is intended to be within the scope of the term.

The input signals (or combination of signals) may be representative of conditions of the battery system such as voltage, current drawn by loads connected to the battery, resistance, temperature, state of health, deliverable power, deliverable energy, capacity, time, battery condition, period since last discharge, etc. according to exemplary embodiments. The input signals provided to the battery management system may also be representative of a condition of the systems, subsystems and/or components of systems and/or subsystems of the vehicle (e.g., loads of the electrical system) according to other exemplary embodiments. The various signals may be measured directly or may be determined indirectly from a signal obtained from a sensor, alone or in combination with other signals or parameters used by computation, etc. The range of pre-selected values (e.g., operating or pre-selected parameters) that are compared to the input signals may be preprogrammed and/or determined during operation, use, testing, etc. of the vehicle. The range of pre-selected values may be adjusted or calibrated over time according to other exemplary embodiments. The range of pre-selected values that may be reset or otherwise adjusted or calibrated for changes in use or other factors relating to the vehicle or the battery system according to other exemplary embodiments.

The battery system includes a lead-acid battery for an automobile according to an exemplary embodiment. A suitable low voltage battery includes a 12V or 14V absorptive glass mat (AGM) valve regulated lead-acid (VLRA) battery such as a 12V Red Top Optima battery commercially available from Optima Batteries, Inc. of Boulder, Colo. Another suitable low voltage battery includes the 12V or 14V DieHard battery commercially available from Sears, Roebuck and Co. of Hoffman Estates, Ill. A suitable high voltage battery includes the 36V or 42V 2.4 amp hour (AH) Inspira battery commercially available from Johnson Controls Battery Group, Inc. of Milwaukee, Wis. The battery system may include three 12V batteries connected in series to form a 36V battery pack according to another exemplary embodiment. Various batteries may be used according to other exemplary embodiments.

The battery management system may comprise a computing device, microprocessor, controller or programmable logic controller (PLC) for implementing a control program, and which provides output signals based on input signals provided by a sensor or that are otherwise acquired. Any suitable computing device of any type may be included in the battery management system according to other exemplary embodiments. For example, computing devices of a type that may comprise a microprocessor, microcomputer or programmable digital processor, with associated software, operating systems and/or any other associated programs to implement the control program may be employed. The controller and its associated control program may be implemented in hardware, software, firmware, or a combination thereof, or in a central program implemented in any of a variety of forms (e.g., hardware and/or software and/or firmware) according to other exemplary embodiments. A single control system may regulate the controller for the battery management system and the controller for the vehicle (i.e., the battery management system may be installed on a shared component system) according to any exemplary embodiment.

The switch may be a “solid state” switch comprising primarily semi-conducting materials and components, such as a metal oxide semiconductor field effect transistor (“MOSFET”) according to an exemplary embodiment. The switch may be mechanical switches or relays that respond to a current or voltage change to connect and disconnect the loads from the battery system according to another exemplary embodiment. The switch may include a manually activated main or system switch to disconnect all loads of the electrical system from the battery system according to another exemplary embodiment.

Data links or wires are provided for allowing data communication between the various components of the control system. For example, data or signals may be transmitted along a data link between a device or sensor for providing an input signal representative of a condition of a component of the vehicle and the battery management system.

Those of skill in the art who review this disclosure will understand that a variety of advantageous features may be provided by a battery management system such as that disclosed herein. According to an exemplary embodiment, a battery management system determines if a vehicle engine is operating by analyzing a ripple voltage indicating that an alternator is operating and/or analyzing a pattern provided by various loads to determine whether a vehicle start has occurred.

According to another exemplary embodiment, a battery management system determines whether a vehicle engine is “off” and then sheds one or more vehicle loads, provides an output signal to notify a vehicle system and/or a driver of the disconnection of the load(s). The battery management system may then send a signal to start the vehicle engine.

According to another exemplary embodiment, a battery management system judges a condition of a battery based on starting voltages and/or currents.

According to another exemplary embodiment, a battery management system collects information in a look-up table, judges future battery operation against values in the look-up table, and determines the condition of the battery.

According to another exemplary embodiment, a battery management system detects an attempt to start a vehicle without proper authorization and disables a system for starting the vehicle engine. The determination that there is no proper authorization may utilize, for example, GPS location, odometer trip length, and/or other information.

According to another exemplary embodiment, a battery management system prevents engine turn-off in the event that a vehicle is still in motion and/or high power is likely to be required in the future.

According to another exemplary embodiment, a battery management system determines if an impact or collision has occurred and signals to disconnect certain loads (e.g., non-“emergency” loads) from the battery. The battery management system may also disconnect the battery from all loads if battery drain is likely to occur beyond a predetermined threshold.

According to another exemplary embodiment, a battery management system calculates the state-of-charge (“SOC”) of a battery based on battery behavior as opposed to amp-hour integration, and provides a signal based on this calculation. For example, the battery management system may signal that the battery should be recharged or that the vehicle engine should not be turned off if the SOC of the battery is below a predetermined threshold. The battery management system may also signal that the alternator should be turned off if the SOC is above a predetermined threshold.

According to another exemplary embodiment, a battery management system collects, stores, and utilizes vehicle information (as opposed to only battery or engine information) for use in various calculations and/or algorithms (e.g., to characterize or determine recent vehicle use parameters, to determine if the vehicle is in motion, to determine whether an impact has occurred, etc.).

According to another exemplary embodiment, a battery management system utilizes information relating to a battery and/or the condition of the battery derived from input signals representing battery performance and/or operation, keypad entry of information, and other information.

According to another exemplary embodiment, a battery management system prioritizes electrical loads to allow disconnection from certain loads according to a predetermined hierarchy. For example, loads deemed non-essential may be disconnected before those that are deemed essential.

It is important to note that the construction and arrangement of the elements of the battery management system as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed in this application. Accordingly, all such modifications are intended to be included within the scope of the present inventions. The order or sequence of any process or method steps may be varied or re-sequenced according to other exemplary embodiments. In any claims, any means-plus-function clause is intended to cover the structures described herein as performing the recited function and not only structural equivalents but also equivalent structures. Features described with regard to a particular exemplary embodiment may be utilized in conjunction with features described with regard to other exemplary embodiments. Other substitutions, modifications, changes and omissions may be made in the design, operating conditions and arrangement of the preferred and other exemplary embodiments without departing from the scope of the present inventions.

1. A method for managing a battery system for a vehicle having components and systems that includes at least one battery and that is configured to provide power to a plurality of electrical loads comprising:
receiving an input signal representative of a condition of one of the components of one of the systems provided in a vehicle;
comparing the input signal with at least one parameter to determine whether the condition indicates that at least one of the plurality of electrical loads should be disconnected from the at least one battery; and
disconnecting at least one of the plurality of electrical loads from the at least one battery according to a predetermined hierarchy if the input signal when compared to the parameter indicates that at least one of the plurality of electrical loads should be disconnected from the at least one battery.

2. The method of claim 1 wherein the step of disconnecting at least one of the plurality of electrical loads comprises disconnecting a plurality of electrical loads.

3. The method of claim 2 wherein the step of disconnecting a plurality of electrical loads according to a predetermined hierarchy comprises disconnecting electrical loads designated as nonessential before disconnecting electrical loads designated as essential.

4. The method of claim 3 wherein the loads designated as nonessential are selected from an adapter outlet, an entertainment system, a seating positioning device, a climate control system, and an interior lighting system.

5. The method of claim 3 wherein the loads designated as essential are selected from a vehicle starter, a fuel pump, a lighting system, a steering system, a headlight system, a window defroster, and a windshield wiper system.

6. The method of claim 1 further comprising providing a notification if the input signal when compared to the parameter indicates that at least one of the plurality of electrical loads should be disconnected from the at least one battery.

7. The method of claim 1 wherein the input signal is representative of a state of charge of a battery and wherein the step of disconnecting at least one of the plurality of electrical loads comprises disconnecting the at least one electrical load when the state of charge of the battery is less than a predetermined value.

8. The method of claim 1 wherein the input signal is representative of the use of the vehicle and wherein the step of disconnecting at least one of the plurality of electrical loads comprises disconnecting the at least one electrical load when the use of the vehicle is determined to be unauthorized.

9. The method of claim 8 further comprising providing a notification to a vehicle assistance provider, the notification selected from a phone call, a text message, and an electronic mail message.

10. The method of claim 8 further comprising disabling the engine of the vehicle to prevent an unauthorized start of the engine when it is determined that the engine is off.

11. The method of claim 8 wherein the input signal is representative of at least one of the location of the vehicle, the speed of the vehicle, and the time of use of the vehicle.

12. The method of claim 1 wherein the input signal is representative of a vehicle collision and wherein the step of disconnecting at least one of the plurality of electrical loads comprises disconnecting the at least one electrical load when the vehicle is determined to have been involved in a collision.

13. The method of claim 1 wherein the input signal is representative of the whether the engine of the vehicle is off and wherein the step of disconnecting at least one of the plurality of electrical loads comprises disconnecting the at least one electrical load when the engine of the vehicle is determined to be off.

14. The method of claim 1 wherein the input signal is representative of a failure of an electrical load and wherein the step of disconnecting at least one of the plurality of electrical loads comprises disconnecting the electrical load that has failed.

15. The method of claim 1 further comprising providing an output signal to charge the at least one battery when the input signal is representative of a low battery charge condition.

16. The method of claim 1 further comprising determining whether the vehicle is in use before disconnecting at least one of the plurality of electrical loads and wherein the step of disconnecting at least one of the plurality of electrical loads is performed only when the vehicle is determined not to be in use.

17. The method of claim 16 wherein the step of determining whether the vehicle is in use comprises receiving an input signal representative of a ripple voltage.

18. The method of claim 16 wherein the step of determining whether the vehicle is in use comprises receiving an input signal from a sensor associated with at least one of a tachometer, an accelerometer, a global positioning system, a fuel pump, a vehicle ignition, and a vehicle lighting system.

19. The method of claim 1 further comprising disconnecting a plurality of electrical loads to maintain a pre-determined state of charge of the at least one battery.

20. A system for managing a battery system including at least one battery provided in a vehicle having a plurality of systems and components and configured to provide power to a plurality of electrical loads comprising:
a control program for comparing an input signal representative of a condition of a component of a system provided in a vehicle to a parameter for the component and for providing an output signal to disconnect at least one of the plurality of electrical loads from the at least one battery according to a predetermined hierarchy if the input signal when compared to the parameter indicates that at least one of the plurality of electrical loads should be disconnected from the at least one battery.

21. The system of claim 20 further comprising a device for providing the input signal.

22. The system of claim 21 wherein the device comprises at least one sensor.

23. The system of claim 22 wherein the sensor is associated with at least one of a tachometer, an accelerometer, a global positioning system, and a speedometer.

24. The system of claim 21 wherein the device comprises a network.

25. The system of claim 24 wherein the device comprises a vehicle communication system.

26. The system of claim 20 further comprising a switch for disconnecting the at least one electrical load from the at least one battery.

27. The system of claim 20 wherein the battery system includes a low voltage battery for low voltage electrical loads and a high voltage battery for high voltage electrical loads.

28. The system of claim 20 wherein the control program is configured to provide an output signal to provide a charging current to the battery system to maintain a predetermined state of charge of the battery system.

29. The system of claim 20 wherein the control program is configured to provide at least one of an audible signal and a visual signal if the input signal when compared to the parameter indicates that at least one of the plurality of electrical loads should be disconnected from the at least one battery.

30. The system of claim 20 wherein the control program is configured to disconnect loads designated as nonessential before disconnecting loads designated a essential.

31. A control system for a vehicle comprising:
a battery system comprising at least one battery;
a plurality of electrical loads configured to receive power from the battery system;
a switch for selectively electrically connecting at least one of the plurality of electrical loads to the battery system; and
a device for providing an output signal to the switch to disconnect the at least one of the plurality of electrical loads from the battery system according to a predetermined hierarchy;
wherein the device is configured to receive an input signal representative of a condition of a component of the vehicle and to compare the input signal to a parameter and to provide the output signal if the input signal when compared to the parameter indicates that the at least one of the plurality of electrical loads should be disconnected from the battery system.

32. The control system of claim 31 wherein the battery system comprises a low voltage battery for powering low voltage loads.

33. The control system of claim 32 wherein the battery system further comprises a high voltage battery for powering high voltage loads.

34. The control system of claim 31 wherein the plurality of electrical loads include loads designated as essential and loads designated as nonessential.

35. The control system of claim 34 wherein the device is configured to provide at least one output signal to disconnect a plurality of loads designated as nonessential according to a predetermined hierarchy.

36. The control system of claim 35 wherein the device is configured to provide at least one output signal to disconnect a plurality of loads designated as essential according to a predetermined hierarchy after all of the loads designated as nonessential are disconnected.

37. The control system of claim 31 wherein the device is a controller configured to run a control program.

38. The control system of claim 31 wherein the input signal is representative of a state of charge of a battery and the control program provides an output signal to disconnect at least one of the plurality of electrical loads when the state of charge of the battery is less than a predetermined value.

39. The control system of claim 31 wherein the input signal is representative of the use of the vehicle and the control program provides an output signal to disconnect at least one of the plurality of electrical loads when the use of the vehicle is determined to be unauthorized.

40. The control system of claim 31 wherein the input signal is representative of a vehicle collision and the control program provides an output signal to disconnect at least one of the plurality of electrical loads when the vehicle is determined to have been involved in a collision.

41. The control system of claim 31 wherein the input signal is representative of the whether the engine of the vehicle is off and the control program provides an output signal to disconnect at least one of the plurality of electrical loads when the engine of the vehicle is determined to be off.

42. The control system of claim 31 wherein the input signal is representative of a failure of an electrical load and the control program provides an output signal to disconnect the load that has failed.
